(19) United States
(12) Patent Application Publication
(10) Pub. No.: US 2015/0109266 A1
(43) Pub. Date: Apr. 23, 2015

(54) DISPLAY PANEL AND METHOD OF MANUFACTURING THE SAME

(71) Applicant: Samsung Display Co., Ltd., Yongin-City (KR)

(72) Inventors: Sung-Hee HONG, Hwaseong-si (KR); Jang-Il KIM, Asan-si (KR); Sei-Yong PARK, Suwon-si (KR); Hyoung-Cheol LEE, Suwon-si (KR); Yeo-Geon YOON, Suwon-si (KR)

(21) Appl. No.: 14/466,802

(22) Filed: Aug. 22, 2014

(30) Foreign Application Priority Data
Oct. 21, 2013 (KR) 10-2013-0125231

(51) Int. Cl. G09G 3/36

(52) U.S. Cl. CPC G09G 3/3648
USPC 345/205; 345/103

(57) ABSTRACT

A display panel includes a gate line extending substantially in a first direction, a first data line extending in a second direction substantially perpendicular to the first direction and a first switching element comprising a first electrode, a second electrode and a channel layer, where an end portion of the first electrode has a first edge oriented substantially perpendicular to a direction of extension of the first electrode, and the second electrode extends in a direction substantially opposite to the first electrode and an end portion of the second electrode has a second edge oriented substantially perpendicular to a direction of extension of the second electrode, and the channel layer substantially entirely covers both a lower surface of the first electrode and a lower surface of the second electrode.

This application claims priority to Korean Patent Application No. 10-2013-0125231 filed on Oct. 21, 2013, the contents of which are incorporated herein by reference in their entirety.

### BACKGROUND

1. Field of Disclosure

Exemplary embodiments of the invention relate to a display panel and a method of manufacturing the display panel.

More particularly, exemplary embodiments of the present invention relate to a display panel for a liquid crystal display apparatus and a method of manufacturing the display panel.

2. Description of the Related Art

Liquid crystal displays have earned recent attention for their relative light weight and small size. A cathode ray tube (CRT) display apparatus has been traditionally used due to performance and its competitive price. However the CRT display apparatus has a weakness with regard to size or portability. The liquid crystal display apparatus has been seen as a solution to this problem, due to its small size, light weight and low-power-consumption.

The liquid crystal display apparatus may include pixels having various structures according to a driving method. There have been various studies to improve an aperture ratio and a transmittance according to the various structures of the pixels.

### SUMMARY

One or more exemplary embodiments of the invention provide a display panel capable of improving a characteristic of a thin film transistor.

One or more exemplary embodiments of the invention also provide a method of manufacturing the display panel.

According to an exemplary embodiment of the invention, a display panel includes a gate line extending substantially in a first direction, a first data line extending in a second direction substantially perpendicular to the first direction and a first switching element comprising a first electrode, a second electrode and a channel layer. An end portion of the first electrode has a first edge oriented substantially perpendicular to a direction of extension of the first electrode. The second electrode extends in a direction substantially opposite to the first electrode and an end portion of the second electrode has a second edge oriented substantially perpendicular to a direction of extension of the second electrode. The channel layer substantially entirely covers both a lower surface of the first electrode and a lower surface of the second electrode.

In an exemplary embodiment, the display panel may further include a second data line spaced apart from the first data line in the first direction, and extending substantially in the second direction; a high pixel electrode disposed between the first data line and the second data line, and disposed adjacent to the gate line; a low pixel electrode disposed between the first data line and the second data line, and disposed opposite to the high pixel electrode with respect to the gate line; a high storage line extending substantially in the second direction, and overlapping the high pixel electrode; and a low storage line extending substantially in the second direction, and overlapping the low pixel electrode.

In an exemplary embodiment, the display panel may further include a second switching element electrically connected to the gate line, the first data line and the high pixel electrode; and a third switching element electrically connected to the gate line and the low pixel electrode. The first electrode of the first switching element may be electrically connected to the high storage line, and the second electrode of the first switching element may be electrically connected to the third switching element.

In an exemplary embodiment, the high storage line may include a first high storage line extending substantially in the first direction and a second high storage line extending substantially in the second direction. The low storage line may comprise a first low storage line extending substantially in the first direction and a second low storage line extending substantially in the second direction.

In an exemplary embodiment, the high pixel electrode may include a first stem extending substantially in the first direction, a second stem extending substantially in the second direction, and a plurality of branches extending from the first and second stems. The high pixel electrode may have a slit structure formed by the branches. The low pixel electrode may include a first stem extending substantially in the first direction, a second stem extending substantially in the second direction, and a plurality of branches extending from the first and second stems. The low pixel electrode may have a slit structure formed by the branches. The second high storage line may overlap the second stem of the high pixel electrode. The second low storage line may overlap the second stem of the low pixel electrode.

In an exemplary embodiment, the display panel may further include a connecting electrode electrically connecting the high storage line to the low storage line.

In an exemplary embodiment, the display panel may further include a common electrode facing the high pixel electrode and the low pixel electrode, and a liquid crystal layer disposed between the high and low pixel electrodes and the common electrode.

In an exemplary embodiment, the first electrode and the second electrode may have a substantially rectangular shape in plan view.

In an exemplary embodiment, wherein the first electrode and the second electrode may have a substantially trapezoidal shape in plan view.

In an exemplary embodiment, a first side of at least one of the first and second electrodes may be substantially parallel to the first data line and a second side of the at least one of the first and second electrodes, which is opposite to the first side, may not be parallel to the first data line.

In an exemplary embodiment, a portion of the high pixel electrode may overlap the first and second data lines and a portion of the low pixel electrode may overlap the first and second data lines.

In an exemplary embodiment, the high storage line, the low storage line and the gate line may be formed from a same layer.

According to another exemplary embodiment of the invention, a method of manufacturing a display panel includes forming a gate pattern comprising a gate line, a high storage line and a low storage line on a substrate, and forming a first insulation layer on the substrate. Also included is forming a first data line, a second data line, a data pattern and an active pattern, where the data pattern comprises a first electrode and a second electrode, and an end portion of the first electrode has a first edge substantially perpendicular to a direction of extension of the first electrode, the second electrode extends in a direction substantially opposite to the first electrode, an end portion of the second electrode has a second edge substantially perpendicular to a direction of extension of the second electrode, and the active pattern is disposed under the data pattern to substantially entirely cover a lower surface of the data pattern. Also included is forming a second insulation layer on the first insulation layer, as well as and forming a high pixel electrode, a low pixel electrode and a connecting electrode connecting the high storage line and the low storage line.

In an exemplary embodiment, the gate line may extend substantially in a first direction, the first data line may extend in a second direction substantially perpendicular to the first direction, and the second data line may be spaced apart from the first data line in the first direction, and may extend substantially in the second direction. The high pixel electrode may be disposed between the first data line and the second data line and disposed adjacent to the gate line, and the low pixel may be electrode disposed between the first data line and the second data line and disposed opposite to the high pixel electrode with respect to the gate line. The high storage line may extend substantially in the second direction and overlap the high pixel electrode. The low storage line may extend substantially in the second direction and overlap the low pixel electrode.

In an exemplary embodiment, the gate line, the first data line and the high pixel electrode may be electrically connected to a second switching element. The gate line, the first data line and the low pixel electrode may be electrically connected to a third switching element. The gate line, the third switching element and the high storage line may be electrically connected to a first switching element.

In an exemplary embodiment, the of manufacturing a display panel may further include forming a first contact hole through the first insulation layer to expose the high storage line before forming the data pattern. The high storage line may be connected to a first electrode of the first switching element through the first contact hole.

In an exemplary embodiment, the manufacturing a display panel may further include forming a second contact hole through the second insulation layer to expose the first electrode of the first switching element, and forming a third contact hole through the second and first insulation layer to expose the low storage line before forming the connecting electrode. The connecting electrode may be electrically connected to the high storage line and to a first source electrode of the first switching element through the first and second contact holes, and may be electrically connected to the low storage line through the third contact hole.

In an exemplary embodiment, the first electrode and the second electrode may have a substantially rectangular shape in plan view.

In an exemplary embodiment, the first electrode and the second electrode may have a substantially trapezoidal shape in plan view.

In an exemplary embodiment, a first side of one of the first and second electrodes may be substantially parallel to the first data line and a second side of one of the first and second electrodes, which is opposite to the first side, may not be parallel to the first data line.

According to the present invention, a channel portion, a source electrode and a drain electrode are formed by using the same mask. Accordingly, when ends of a source electrode and a drain electrode are substantially parallel to the gate line, an end of the channel portion may be substantially parallel to the gate line.

In addition, the end of the channel portion is formed to have a straight edge in plan view, so that a width of the channel portion may be measured accurately.

In addition, since a width of the channel portion is measured accurately, a dispersion may be decreased and a display quality may improved.

### BRIEF DESCRIPTION OF THE DRAWINGS

The above and other features of the invention will become more apparent by describing in detail exemplary embodiments thereof with reference to the accompanying drawings, in which:

FIG. 1 is a plan view illustrating a pixel of a display panel according to an exemplary embodiment of the invention;

FIG. 2 is a partially enlarged view illustrating a switching element of FIG. 1;

FIG. 3 is a equivalent circuit diagram of the pixel of FIG. 1;

FIG. 4 is a plan view illustrating a pixel of a display panel according to another exemplary embodiment of the invention;

FIG. 5 is a plan view illustrating a pixel of a display panel according to still another exemplary embodiment of the invention;

FIG. 6 is a cross-sectional view taken along a line I-I′ of FIG. 5;

FIG. 7 is a cross-sectional view illustrating a display panel according to still another exemplary embodiment of the invention;

FIGS. 8A to 14 are cross-sectional views illustrating a method of manufacturing the display panel of FIG. 5;

FIG. 15 is a partially enlarged view illustrating a first switching element according to an exemplary embodiment of the invention;

FIG. 16 is a partially enlarged view illustrating a first switching element according to another exemplary embodiment of the invention; and

FIG. 17 is a partially enlarged view illustrating a first switching element according to still another exemplary embodiment of the invention.

### DETAILED DESCRIPTION

Hereinafter, the invention will be explained in detail with reference to the accompanying drawings, which are not necessarily to scale.

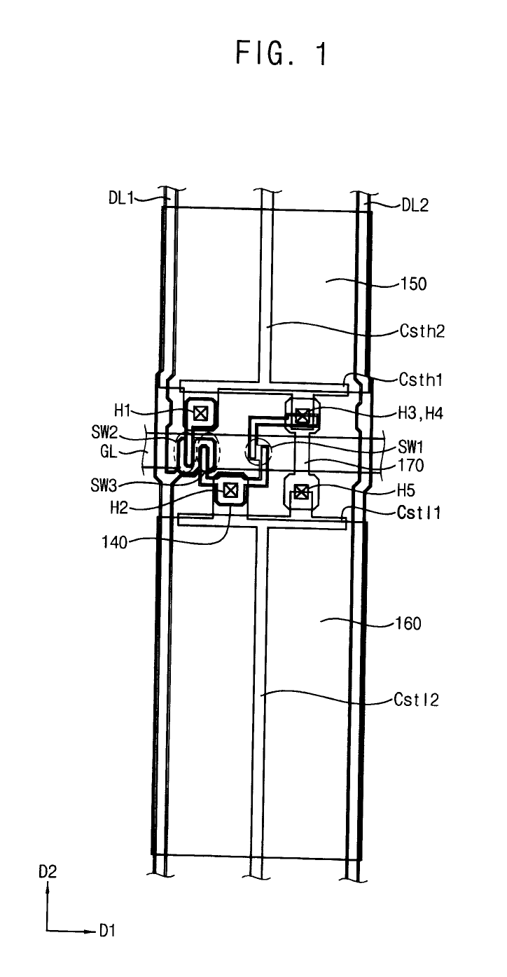

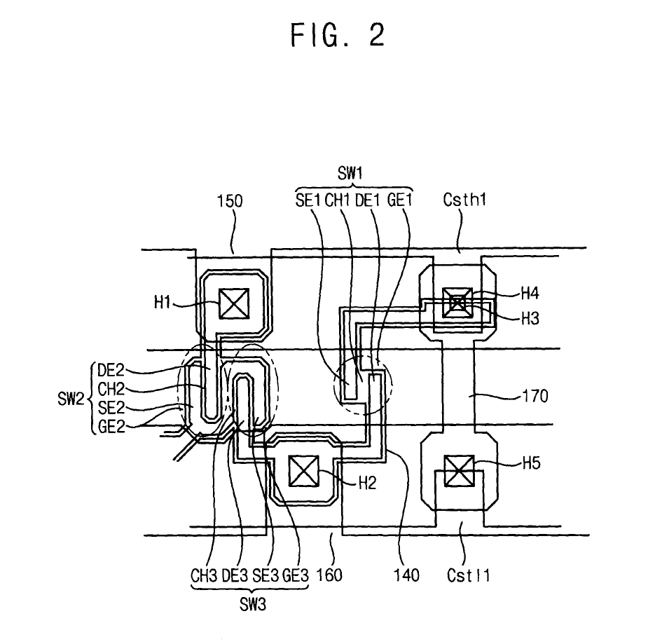

FIG. 1 is a plan view illustrating a pixel of a display panel according to an exemplary embodiment of the invention. FIG. 2 is a partially enlarged view illustrating a switching element of FIG. 1. One pixel is illustrated and explained for convenience of description.

Referring to FIGS. 1 and 2, a display panel includes a gate line GL, a first data line DL1, a second data line DL2, a first high storage line Csth1, a second high storage line Csth2, a first low storage line Cstl1, a second low storage line Cstl2, a first switching element SW1, a second switching element SW2, a third switching element SW3, a channel layer 140, a high pixel electrode 150, a low pixel electrode 160 and a connecting electrode 170.

The gate line GL extends substantially in a first direction D1. The gate line GL is electrically connected to a first gate electrode GE1 of the first switching element SW1, a second gate electrode GE2 of the second switching element SW2, and a third gate electrode GE3 of the third switching element SW3. In addition, portions of the gate line GL may form the first gate electrode GE1, the second gate electrode GE2, and the third gate electrode GE3.

The first data line DL1 extends in a second direction D2 substantially perpendicular to the first direction D1, and crosses the gate line GL. The first data line DL1 is electrically connected to a second source electrode SE2 of the second switching element SW2, and a third source electrode SE3 of the third switching element SW3.

The second data line DL2 is spaced apart from the first data line DL1, extends in the second direction D2, and crosses the gate line GL. The second data line DL2 is electrically connected to a second source electrode of a second switching element of an adjacent pixel, and a third source electrode of the third switching element of the adjacent pixel.

The channel layer 140 entirely covers a lower surface of a data pattern. The data pattern may include the first data line DL1, the second data line DL2, a first source electrode SE1 and a first drain electrode DE1 of the first switching element SW1, a second source electrode SE2 and a second drain electrode DE2 of the second switching element SW2, a third source electrode SE3 and a third drain electrode DE3 of the third switching element SW3. The channel layer 140 and the data pattern may be formed by using the same mask. Thus, the channel layer 140 may be formed to have a shape corresponding to the data pattern. In the present exemplary embodiment, the channel layer 140 and the data pattern may be formed by using the same mask, so that the number of processes and associated manufacturing cost may be decreased.

The high pixel electrode 150 is disposed adjacent to the gate line GL in the second direction D2, and between the first data line DL1 and the second data line DL2. The high pixel electrode 150 is electrically connected to a second drain electrode DE2 of the second switching element SW2 through a first contact hole H1. A boundary of the high pixel electrode 150 may overlap the first data line DL1 and the second data line DL2.

The low pixel electrode 160 is disposed opposite to the high pixel electrode 150 with reference to the gate line GL, and between the first data line DL1 and the second data line DL2. The low pixel electrode 160 is electrically connected to the third drain electrode DE3 of the third switching element SW3 through a second contact hole H2. A boundary of the low pixel electrode 160 may overlap the first data line DL1 and the second data line DL2.

A first voltage may be applied to the high pixel electrode 150. A second voltage different from the first voltage may be applied to the low pixel electrode 160. For example, the first voltage may be higher than the second voltage, a portion of the pixel corresponding to the high pixel electrode 150 may be driven as a high pixel, and another portion of the pixel corresponding to the low pixel electrode 160 may be driven as a low pixel.

The first high storage line Csth1 extends substantially in the first direction D1, and is disposed adjacent to the gate line GL. The first high storage line Csth1 is disposed between the first data line DL1 and the second data line DL2, and does not overlap either of the first and second data lines DL1 and DL2. The first high storage line Csth1 may overlap a boundary of the high pixel electrode 150. The first high storage line Csth1 is electrically connected to the first source electrode SE1 of the first switching element SW1 though a third contact hole H3. The first high storage line Csth1 is also electrically connected to the connecting electrode 170 through a fourth contact hole H4.

The second high storage line Csth2 is disposed between the first data line DL1 and the second data line DL2, and extends substantially in the second direction D2. The second high storage line Csth2 overlaps the high pixel electrode 150. The second high storage line Csth2 is electrically connected to the first high storage line Csth1. The second high storage line Csth2 is disposed in the middle of the high pixel electrode 150, so that the second high storage line Csth2 divides the high pixel electrode 150 into two portions.

The first low storage line Cstl1 is disposed adjacent to the gate line GL, and opposite to the first high storage line Csth1 with reference to the gate line GL. The first low storage line Cstl1 extends substantially in the first direction D1. The first low storage line Cstl1 is disposed between the first data line DL1 and the second data line DL2, and does not overlap either of the first and second data lines DL1 and DL2. The first low storage line Cstl1 may overlap a boundary of the low pixel electrode 160. The first low storage line Cstl1 is electrically connected to the connecting electrode 170 through a fifth contact hole H5.

The second low storage line Cstl2 is disposed between the first data line DL1 and the second data line DL2, and extends substantially in the second direction D2. The second low storage line Cstl2 overlaps the low pixel electrode 160. The second low storage line Cstl2 is electrically connected to the first low storage line Cstl1. The second low storage line Cstl2 is disposed in the middle of the low pixel electrode 160, so that the second low storage line Cstl2 divides the low pixel electrode 160 into two portions.

The second high storage line Csth2 is electrically connected to a second low storage line of an adjacent pixel in the second direction D2. In addition, the second low storage line Cstl2 is electrically connected to a second high storage line of an adjacent pixel in the second direction D2. Thus, in the whole display panel, second high storage lines and second low storage lines are connected to each other along the second direction D2.

The first switching element SW1 includes the first gate electrode GE1, the first source electrode SE1, the first drain electrode DE1 and a first channel portion CH1 connecting the first source electrode SE1 to the first drain electrode DE1.

The first source electrode SE1 may have a portion extending in the second direction D2. An end portion of the first source electrode SE1 may have an edge oriented substantially parallel to the gate line GL.

The first drain electrode DE1 is spaced apart from the first source electrode SE1.

The first drain electrode DE1 may be staggered with the first source electrode SE1. The first drain electrode DE1 may have a portion extending in the second direction D2. An end portion of the first drain electrode DE1 may have an edge oriented substantially parallel to the gate line GL.

The first drain electrode DE1 and the first source electrode SE1 may have portions extend in the second direction D2. However, shapes of the first drain electrode DE1 and the first source electrode SE1 are not limited thereto. The first drain electrode DE1 and the first source electrode SE1 may partially or fully extend in the first direction D1. At this time, an end portion of the first source electrode SE1 may have an edge substantially parallel to the first data line DL1. Also, an end portion of the first drain electrode DE1 may have an edge substantially parallel to the first data line DL1.

The first channel portion CH1 may include a semiconductor layer that includes amorphous silicon (a-Si:H) and an ohmic contact layer that includes n+ amorphous silicon (n+ a-Si:H). In addition, the first channel portion CH1 may include an oxide semiconductor. The oxide semiconductor may include an amorphous oxide including at least one selected from the group consisting of indium (In), zinc (Zn), gallium (Ga), tin (Sn) and hafnium (Hf).

The second switching element SW2 includes the second gate electrode GE2, the second source electrode SE2, the second drain electrode DE2 and a second channel portion CH2 connecting the second source electrode SE2 to the second drain electrode DE2.

The second channel portion CH2 may include a semiconductor layer that includes amorphous silicon (a-Si:H) and an ohmic contact layer that includes n+ amorphous silicon (n+ a-Si:H). In addition, the first channel portion CH1 may include an oxide semiconductor. The oxide semiconductor may include an amorphous oxide including at least one selected from the group consisting of indium (In), zinc (Zn), gallium (Ga), tin (Sn) and hafnium (Hf).

The third switching element SW3 includes the third gate electrode GE3, the third source electrode SE3, the third drain electrode DE3 and a third channel portion CH3 connecting the third source electrode SE3 to the third drain electrode DE3.

The third channel portion CH3 may include a semiconductor layer that includes amorphous silicon (a-Si:H) and an ohmic contact layer that includes n+ amorphous silicon (n+ a-Si:H). In addition, the first channel portion CH1 may include an oxide semiconductor. The oxide semiconductor may include an amorphous oxide including at least one selected from the group consisting of indium (In), zinc (Zn), gallium (Ga), tin (Sn) and hafnium (Hf).

The connecting electrode 170 is electrically connected to the first source electrode SE1 of the first switching element SW1 and the first high storage line Csth1 through the third contact hole H3 and the fourth contact hole H4. In addition, the connecting electrode 170 extends substantially in the second direction D2, and is electrically connected to the first low storage line Cstl1 through the fifth contact hole H5.

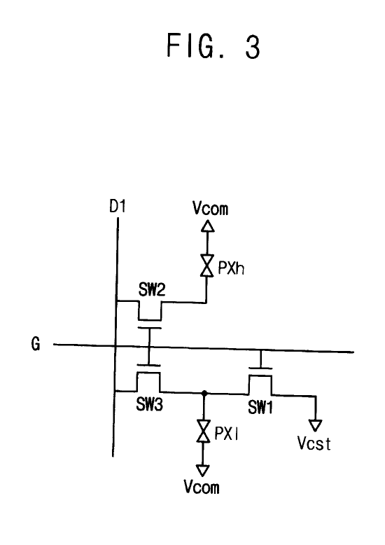

FIG. 3 is an equivalent circuit diagram of the pixel of FIG. 1.

Referring to FIG. 3, a pixel of a display panel includes a first data line receiving a first data signal D1, a gate line receiving a gate signal G, a first switching element SW1, a second switching element SW2, a third switching element SW3, a high pixel liquid crystal capacitor PXh, and a low pixel liquid crystal capacitor PX1.

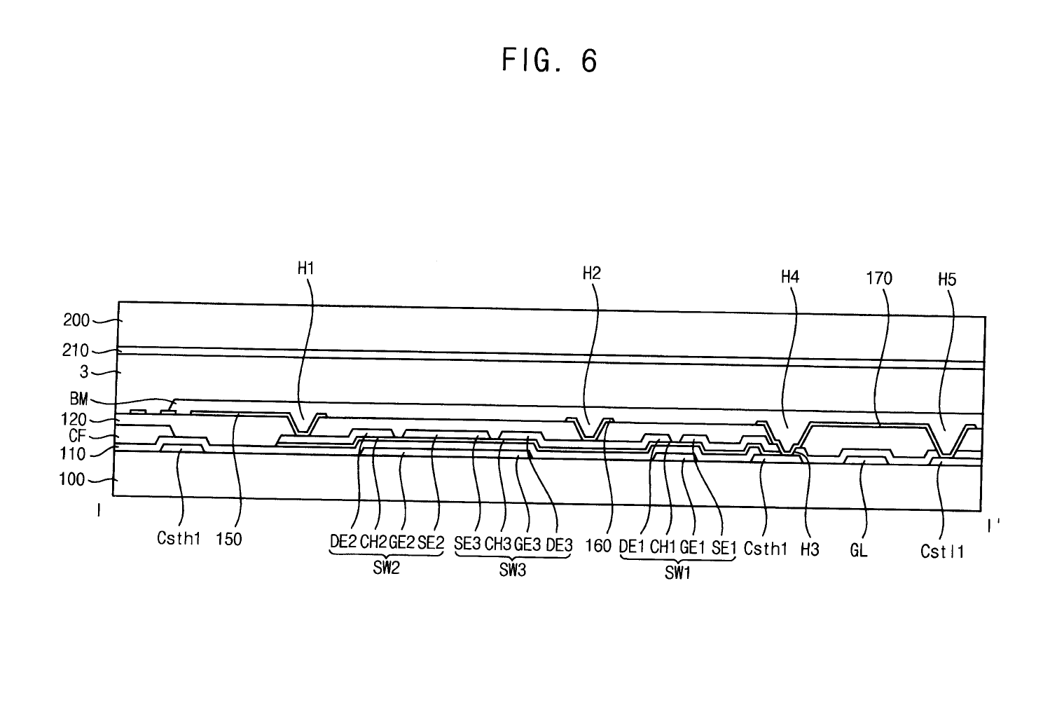

A source electrode of the second switching element SW2 is connected to the first data line. A gate electrode of the second switching element SW2 is connected to the gate line. A drain electrode of the second switching element SW2 is connected to the high pixel liquid crystal capacitor PXh. The high pixel liquid crystal capacitor PXh is formed by a high pixel electrode (reference number 150 of FIG. 1), a common electrode (reference number 210 of FIG. 6) to which a common voltage Vcom is applied, and a liquid crystal layer (reference number 3 of FIG. 6).

A source electrode of the third switching element SW3 is connected to the first data line. A gate electrode of the third switching element SW3 is connected to the gate line. A drain electrode of the third switching element SW3 is connected to a drain electrode of the first switching element SW1 and to the low pixel liquid crystal capacitor PX1. The low pixel liquid crystal capacitor PX1 is formed by a low pixel electrode (reference number 160 of FIG. 1), a common electrode (reference number 210 of FIG. 6) to which a common voltage Vcom is applied, and a liquid crystal layer (reference number 3 of FIG. 6).

A storage voltage Vcst is applied to a source electrode of the first switching electrode SW1. The storage voltage Vcst is applied to first and second high storage lines (reference numbers Csth1 and Csth2 of FIG. 1) and is also applied to first and second low storage lines (reference numbers Cstl1 and Cstl2 of FIG. 1). The first high storage line is connected to the source electrode of the first switching element SW1.

As will be understood by one of ordinary skill in the art, the high pixel electrode and the first and second high storage lines may form a high storage capacitor, and the low pixel electrode and the first and second low storage lines may form a low storage capacitor.

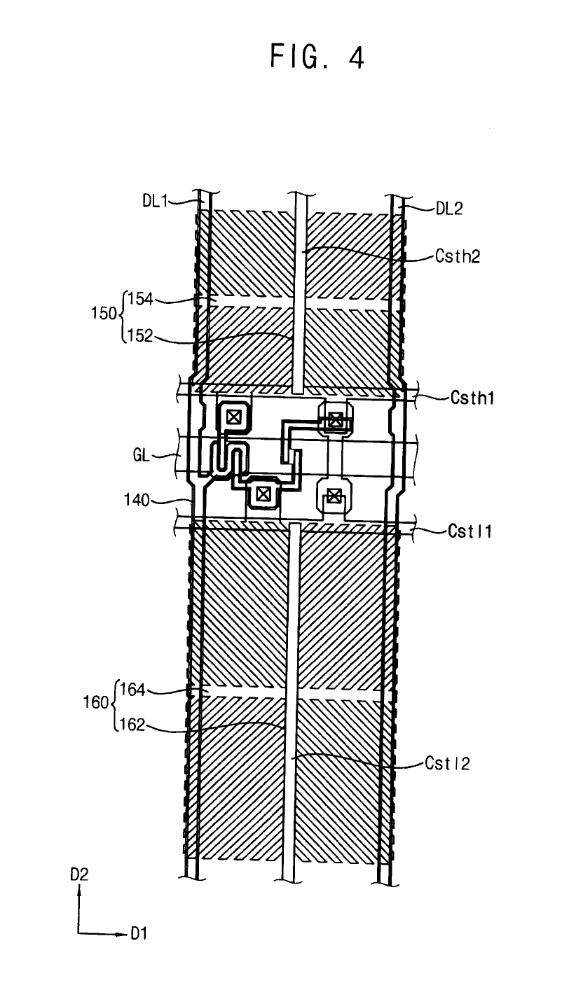

FIG. 4 is a plan view illustrating a pixel of a display panel according to another exemplary embodiment of the invention.

Referring to FIG. 4, a display panel is substantially the same as a display panel of FIG. 1 except for a first high storage line Csth1 and a first low storage line Cstl1, a high pixel electrode 150 and a low pixel electrode 160. Thus, any further detailed descriptions concerning the same elements will be explained only briefly, or omitted.

The display panel includes a gate line GL, a first data line DL1, a second data line DL2, a first high storage line Csth1, a second high storage line Csth2, a first low storage line Cstl1, a second low storage line Cstl2, a high pixel electrode 150 and a low pixel electrode 160.

The gate line GL extends substantially in a first direction D1. The first data line DL1 extends in a second direction D2 substantially perpendicular to the first direction D1, and crosses the gate line GL. The second data line DL2 is spaced apart from the first data line DL1, extends substantially in the second direction D2, and crosses the gate line GL.

The high pixel electrode 150 is disposed adjacent to the gate line GL in the second direction D2. A boundary of the high pixel electrode 150 may overlap the first data line DL1 and the second data line DL2.

The high pixel electrode 150 includes a first stem 152 extending substantially in the second direction D2, and a second stem 154 extending substantially in the first direction D1 and crossing the first stem 152. The first and second stems 152 and 154 may divide the high pixel electrode 150 into four domains. For example, the first and second stems 152 and 154 intersect at a center of the high pixel electrode 150, and divide the high pixel electrode 150 into four domains each of which has the same area.

In each of the domains, a plurality of branches extending from the first or second stems 152 or 154 is formed. The branches form a plurality of slits. The branches may be formed having different directions in each of the four domains. The slits may be opened at boundaries of the high pixel electrode 150.

The low pixel electrode 160 is disposed opposite to the high pixel electrode 150 with reference to the gate line GL. A boundary of the low pixel electrode 160 may overlap the first data line DL1 and the second data line DL2.

The low pixel electrode 160 includes a first stem 162 extending substantially in the second direction D2, and a second stem 164 extending substantially in the first direction D1 and crossing the first stem 162. The first and second stems 162 and 164 may divide the low pixel electrode 160 into four domains. For example, the first and second stems 162 and 164 intersect at a center of the low pixel electrode 160, and divide the low pixel electrode 160 into four domains each of which has the same area.

In each of the domains, a plurality of branches extending from the first or second stems 162 or 164 is formed. The branches form a plurality of slits. The branches may be formed having different directions in each of the four domains. The slits may be opened at boundaries of the low pixel electrode 160.

The first high storage line Csth1 extends substantially in the first direction D1, and is disposed adjacent to the gate line GL. The first high storage line Csth1 is connected to a first high storage line of an adjacent pixel. Thus, the first high storage line Csth1 overlaps the first and second data lines DL1 and DL2.

The second high storage line Csth2 is disposed between the first data line DL1 and the second data line DL2, and extends substantially in the second direction D2. The second high storage line Csth2 overlaps the high pixel electrode 150. The second high storage line Csth2 is connected to the first high storage line Csth1.

The second high storage line Csth2 overlaps the first stem 152 of the high pixel electrode 150.

The first low storage line Cstl1 is disposed adjacent to the gate line GL, and opposite to the first high storage line Csth1 with reference to the gate line GL. The first low storage line Cstl1 extends in the first direction D1. The first low storage line Cstl1 is connected to a first low storage line of an adjacent pixel. Thus, the first low storage line Cstl1 overlaps the first and second data lines DL1 and DL2.

The second low storage line Cstl2 is disposed between the first data line DL1 and the second data line DL2, and extends substantially in the second direction D2. The second low storage line Cstl2 overlaps the low pixel electrode 160. The second low storage line Cstl2 is connected to the first low storage line Cstl1.

The second low storage line Cstl2 overlaps the first stem 162 of the low pixel electrode 160.

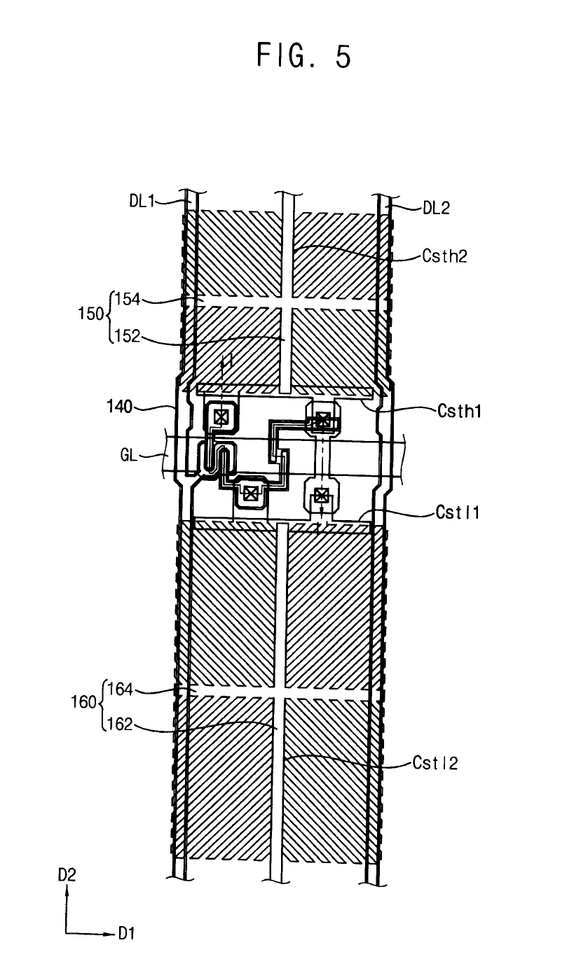

FIG. 5 is a plan view illustrating a pixel of a display panel according to still another exemplary embodiment of the invention.

Referring to FIG. 5, a display panel is substantially the same as a display panel of FIG. 1 except for a first high storage line Csth1 and a first low storage line Cstl1, a high pixel electrode 150 and a low pixel electrode 160. In addition, the high pixel electrode 150 and the low pixel electrode 160 are substantially the same as a high pixel electrode and a low pixel electrode of a display panel of FIG. 4. Thus, any further detailed descriptions concerning the same elements will be explained only briefly, or omitted.

The display panel includes a gate line GL, a first data line DL1, a second data line DL2, a first high storage line Csth1, a second high storage line Csth2, a first low storage line Cstl1, a second low storage line Cstl2, a high pixel electrode 150 and a low pixel electrode 160.

The gate line GL extends substantially in a first direction D1. The first data line DL1 extends in a second direction D2 substantially perpendicular to the first direction D1, and crosses the gate line GL. The second data line DL2 is spaced apart from the first data line DL1, extends substantially in the second direction D2, and crosses the gate line GL.

The high pixel electrode 150 is disposed adjacent to the gate line GL in the second direction D2. A boundary of the high pixel electrode 150 may overlap the first data line DL1 and the second data line DL2.

The high pixel electrode 150 includes a first stem 152 extending substantially in the second direction D2, and a second stem 154 extending substantially in the first direction D1 and crossing the first stem 152. The first and second stems 152 and 154 may divide the high pixel electrode 150 into four domains.

In each of the domains, a plurality of branches extending from the first or second stems 152 or 154 is formed. The branches form a plurality of slits. The branches may be formed having different directions in each of the four domains. The slits may be opened at boundaries of the high pixel electrode 150.

The low pixel electrode 160 is disposed opposite to the high pixel electrode 150 with reference to the gate line GL. A boundary of the low pixel electrode 160 may overlap the first data line DL1 and the second data line DL2.

The low pixel electrode 160 includes a first stem 162 extending substantially in the second direction D2, and a second stem 164 extending substantially in the first direction D1 and crossing the first stem 162. The first and second stems 162 and 164 may divide the low pixel electrode 160 into four domains.

In each of the domains, a plurality of branches extending from the first or second stems 162 or 164 is formed. The branches form a plurality of slits. The branches may be formed having different directions in each of the four domains. The slits may be opened at boundaries of the low pixel electrode 160.

The first high storage line Csth1 extends substantially in the first direction D1, and is disposed adjacent to the gate line GL. The first high storage line Csth1 is disposed between the first data line DL1 and the second data line DL2, and does not overlap either of the first and second data lines DL1 and DL2. The first high storage line Csth1 may overlap a boundary of the high pixel electrode 150.

The second high storage line Csth2 is disposed between the first data line DL1 and the second data line DL2, and extends substantially in the second direction D2. The second high storage line Csth2 overlaps the high pixel electrode 150. The second high storage line Csth2 is connected to the first high storage line Csth1.

The second high storage line Csth2 overlaps the first stem 152 of the high pixel electrode 150.

The first low storage line Cstl1 is disposed adjacent to the gate line GL, and opposite to the first high storage line Csth1 with reference to the gate line GL. The first low storage line Cstl1 extends substantially in the first direction D1. The first low storage line Cstl1 is disposed between the first data line DL1 and the second data line DL2, and does not overlap either of the first and second data lines DL1 and DL2. The first low storage line Cstl1 may overlap a boundary of the low pixel electrode 160.

The second low storage line Cstl2 is disposed between the first data line DL1 and the second data line DL2, and extends substantially in the second direction D2. The second low storage line Cstl2 overlaps the low pixel electrode 160. The second low storage line Cstl2 is connected to the first low storage line Cstl1.

The second low storage line Cstl2 overlaps the first stem 162 of the low pixel electrode 160.

FIG. 6 is a cross-sectional view taken along a line I-I′ of FIG. 5.

Referring to FIG. 6, a display panel includes a first substrate, a second substrate facing the first substrate, and a liquid crystal layer 3 disposed between the first substrate and the second substrate.

The first substrate includes a first base substrate 100, a gate pattern, a first insulation layer 110, a channel layer, a data pattern, a color filter CF, a second insulation layer 120, a high pixel electrode 150, a low pixel electrode 160, a connecting electrode 170 and a black matrix BM.

The first base substrate 100 may include a material which has relatively high transmittance, thermal resistance, and chemical resistance. For example, the first base substrate 100 may include any one selected from the group consisting of glass, polyethylenenaphthalate, polyethylene terephthalate, polyacryl and any mixture thereof

The gate pattern is disposed on the first base substrate 100. The gate pattern includes a first high storage line Csth1, a second high storage line (reference Csth2 of FIG. 5), a first low storage line CstL1, a second low storage line (reference Cstl2 of FIG. 5), a gate line GL, a first gate electrode GE1, a second gate electrode GE2 and a third gate electrode GE3.

The gate pattern may include a metal, a metal alloy, a metal nitride, a conductive metal oxide, a transparent conductive material, or the like. For example, the gate pattern may include copper (Cu) which is opaque.

The first insulation layer 110 is disposed on the gate pattern. The first insulation layer 110 covers and insulates the first high storage line Csth1, the second high storage line, the first low storage line Cstl1, the second low storage line, the gate line GL, the first gate electrode GE1, the second gate electrode GE2 and the third gate electrode GE3.

A third contact hole H3 is formed through the first insulation layer 110 to expose a portion of the first high storage line Csth1.

The channel layer is disposed on the first insulation layer 110. The channel layer includes a first channel portion CH1, a second channel portion CH2, and a third channel portion CH3. The first channel portion CH1 overlaps the first gate electrode GE1. The second channel portion CH2 overlaps the second gate electrode GE2. The third channel portion CH3 overlaps the third gate electrode GE3.

The data pattern is disposed on the channel layer. The data pattern includes a first drain electrode DE1, a first source electrode SE1, a second source electrode SE2, a second drain electrode DE2, a third source electrode SE3, a third drain electrode DE3, a first data line (DL1 of FIG. 1) and a second data line (DL2 of FIG. 1). The data pattern may include a metal, a metal alloy, a metal nitride, a conductive metal oxide, a transparent conductive material, and the like. For example, the data pattern may include copper (Cu) which is opaque.

The first drain electrode DE1, the first source electrode SE1, the first channel portion CH1 and the first gate electrode GE1 collectively form first switching element SW1.

The second drain electrode DE2, the second source electrode SE2, the second channel portion CH2 and the second gate electrode GE2 collectively form second switching element SW2. The second source electrode SE2 is electrically connected to third source electrode SE3.

The third drain electrode DE3, the third source electrode SE3, third channel portion CH3 and the third gate electrode GE3 collectively form third switching element SW3. The third drain electrode DE3 is electrically connected to the first drain electrode DE1. The first source electrode SE1 at least partially fills in a third contact hole H3 formed through the first insulation layer 110.

The color filter CF is disposed on the first insulation layer 110. The color filter CF supplies color to the light passing through liquid crystal layer 3. The color filter CF may include a red color filter, a green color filter and blue color filter, and/or any other desired colors. The color filter CF corresponds to a unit pixel. Color filters adjacent to each other may have different colors. The color filter CF may overlap an adjacent color filter CF in a boundary area between adjacent unit pixels. In addition, the color filter CF may be spaced apart from an adjacent color filter CF in the boundary area between adjacent unit pixels.

The second insulation layer 120 is disposed on the first insulation layer 110 on which the color filter CF and the data pattern are disposed. The second insulation layer 120 covers and insulates the data pattern.

A fourth contact hole H4 is formed through the second insulation layer 120 and over the third contact hole H3, so that a portion of the first high storage line Csth1 and a portion of the first source electrode SE1 are exposed.

A fifth contact hole H5 is formed through the first insulation layer 110 and the second insulation layer 120, so that a portion of the first low storage line Cstl1 is exposed.

A first contact hole H1 is formed through the second insulation layer 120, so that a portion of the second drain electrode DE2 is exposed.

A second contact hole H2 is formed through the second insulation layer 120, so that a portion of the third drain electrode DE3 (or a portion of the first drain electrode DE1) is exposed.

The high pixel electrode 150 is disposed on the second insulation layer 120. The high pixel electrode 150 is electrically connected to the second drain electrode DE2 through the first contact hole H1.

The low pixel electrode 160 is disposed on the second insulation layer 120. The low pixel electrode 160 is electrically connected to the third drain electrode DE3 (or the first drain electrode DE1) through the second contact hole H2.

The connecting electrode 170 is disposed on the second insulation layer 120. The connecting electrode 170 is electrically connected to the first source electrode SE1 through the fourth contact hole H4. In addition, the connecting electrode 170 is electrically connected to the first high storage line Csth1 through the third contact hole H3. Accordingly, the first source electrode SE1, the first high storage line Csth1 and the connecting electrode 170 are electrically connected to each other.

The black matrix BM is disposed on the second insulation layer 120. The black matrix BM blocks light and is disposed corresponding to a non-display area on which an image is not displayed. The non-display area is disposed adjacent to a display area on which the image is displayed. The black matrix BM overlaps, or covers, the first data line, the second data line, and the first to third switching elements SW1, SW2 and SW3. When the gate pattern includes an opaque material, the black matrix BM may overlap the first high storage line Csth1, the second high storage line, the first low storage line Cstl1 and the second low storage line.

The second substrate includes a second base substrate 200 and a common electrode 210.

The second base substrate 200 may include a material which has relatively high transmittance, thermal resistance, and chemical resistance. For example, the second base substrate 200 may include any one selected from the group consisting of glass, polyethylenenaphthalate, polyethylene terephthalate, polyacryl and any mixture thereof

The common electrode 210 is disposed on the second base substrate 200.

The liquid crystal layer 3 is disposed between the first substrate and the second substrate. The liquid crystal layer 3 includes liquid crystal molecules having optical anisotropy. The liquid crystal molecules are driven by electric fields, so that an image is displayed by selectively passing or blocking light through the liquid crystal layer 3.

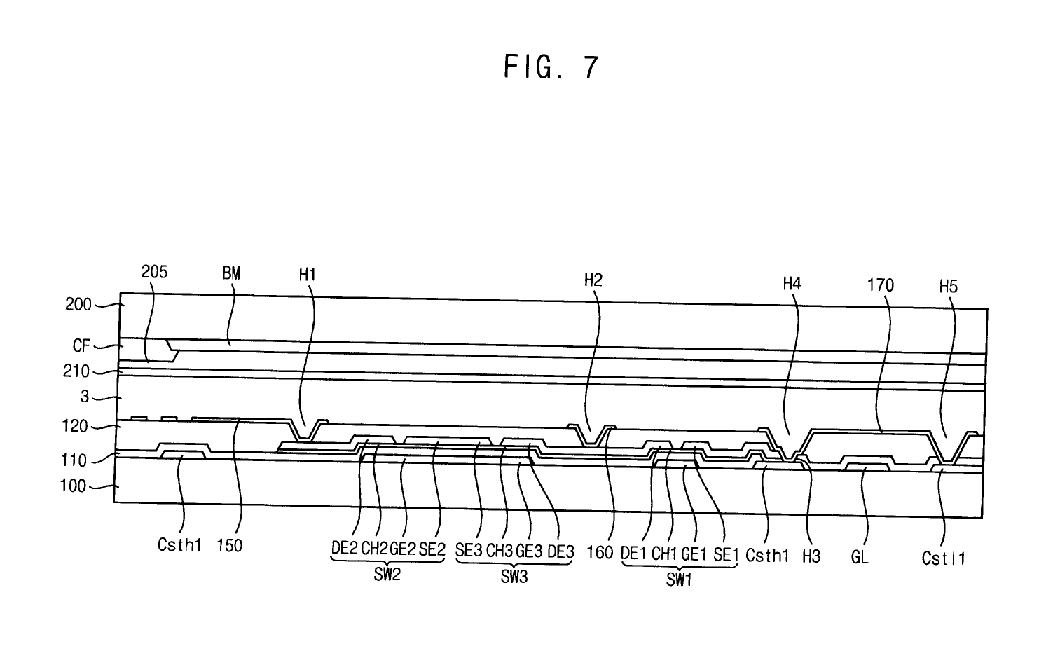

FIG. 7 is a cross-sectional view illustrating a display panel according to still another exemplary embodiment of the invention.

Referring to FIG. 7, a display panel is substantially the same as a display panel of FIG. 6 except for a black matrix BM, a color filter CF and an over-coating layer 205. Thus, any further detailed descriptions concerning the same elements will be explained only briefly, or omitted.

A display panel includes a first substrate, a second substrate facing the first substrate, and a liquid crystal layer 3 disposed between the first substrate and the second substrate.

The first substrate includes a first base substrate 100, a gate pattern, a first insulation layer 110, a channel layer, a data pattern, a second insulation layer 120, a high pixel electrode 150, a low pixel electrode 160 and a connecting electrode 170.

The gate pattern is disposed on the first base substrate 100. The gate pattern includes a first high storage line Csth1, a second high storage line (Csth2 of FIG. 5), a first low storage line Cstl1, a second low storage line (Cstl2 of FIG. 5), a gate line GL, a first gate electrode GE1, a second gate electrode GE2 and a third gate electrode GE3.

The first insulation layer 110 is disposed on the gate pattern. The first insulation layer 110 covers and insulates the first high storage line Csth1, the second high storage line, the first low storage line Cstl1, the second low storage line, the gate line GL, the first gate electrode GE1, the second gate electrode GE2 and the third gate electrode GE3.

A third contact hole H3 is formed through the first insulation layer 110 to expose a portion of the first high storage line Csth1.

The channel layer is disposed on the first insulation layer 110. The channel layer includes a first channel portion CH1, a second channel portion CH2, and a third channel portion CH3. The first channel portion CH1 overlaps the first gate electrode GE1. The second channel portion CH2 overlaps the second gate electrode GE2. The third channel portion CH3 overlaps the third gate electrode GE3.

The data pattern is disposed on the channel layer. The data pattern includes a first drain electrode DE1, a first source electrode SE1, a second source electrode SE2, a second drain electrode DE2, a third source electrode SE3, a third drain electrode DE3, a first data line (DL1 of FIG. 1) and a second data line (DL2 of FIG. 1).

The first drain electrode DE1, the first source electrode SE1, the first channel portion CH1 and the first gate electrode GE1 form a first switching element SW1.

The second drain electrode DE2, the second source electrode SE2, the second channel portion CH2 and the second gate electrode GE2 collectively form second switching element SW2. The second source electrode SE2 is electrically connected to third source electrode SE3.

The third drain electrode DE3, the third source electrode SE3, third channel portion CH3 and the third gate electrode GE3 collectively form third switching element SW3. The third drain electrode DE3 is electrically connected to the first drain electrode DE1. The first source electrode SE1 at least partially fills third contact hole H3 formed through the first insulation layer 110.

The second insulation layer 120 is disposed on the data pattern. The second insulation layer 120 covers and insulates the data pattern.

A fourth contact hole H4 is formed through the second insulation layer 120 and over the third contact hole H3, so that a portion of the first high storage line Csth1 and a portion of the first drain electrode DE1 are exposed.

A fifth contact hole H5 is formed through the first insulation layer 110 and the second insulation layer 120, so that a portion of the first low storage line Cstl1 is exposed.

A first contact hole H1 is formed through the second insulation layer 120, so that a portion of the second drain electrode DE2 is exposed.

A second contact hole H2 is formed through the second insulation layer 120, so that a portion of the third drain electrode DE3 (or a portion of the first drain electrode DE1) is exposed.

The high pixel electrode 150 is disposed on the second insulation layer 120. The high pixel electrode 150 is electrically connected to the second drain electrode DE2 through the first contact hole H1.

The low pixel electrode 160 is disposed on the second insulation layer 120. The low pixel electrode 160 is electrically connected to the third drain electrode DE3 (or the first drain electrode DE1) through the second contact hole H2.

The connecting electrode 170 is disposed on the second insulation layer 120. The connecting electrode 170 is electrically connected to the first source electrode SE1 through the fourth contact hole H4. In addition, the connecting electrode 170 is electrically connected to the first high storage line Csth1 through the third contact hole H3.

Accordingly, the first source electrode SE1, the first high storage line Csth1 and the connecting electrode 170 are electrically connected to each other.

The second substrate includes a second base substrate 200, a black matrix BM, a color filter CF and a common electrode 210.

The black matrix BM is disposed on the second base substrate 200. The black matrix BM overlaps the first data line, the second data line, and the first to third switching elements SW1, SW2 and SW3. When the gate pattern includes an opaque material, the black matrix BM may overlap the first high storage line Csth1, the second high storage line, the first low storage line Cstl1 and the second low storage line.

The color filter CF is disposed on the second base substrate 200. The color filter CF supplies color to the light passing through liquid crystal layer 3. The color filter CF may include a red color filter, a green color filter and blue color filter, as well as filters of any other desired color or colors. The color filter CF corresponds to a unit pixel. Adjacent color filters may have different colors. The color filter CF may overlap an adjacent color filter CF in a boundary area between adjacent unit pixels. In addition, the color filter CF may be spaced apart from an adjacent color filter CF in the boundary area between adjacent unit pixels.

An over-coating layer 205 is disposed on the color filter CF and the black matrix BM. The over-coating layer 205 flattens or planarizes the color filter CF, protects the color filter CF, and insulates the color filter CF. The over-coating layer 205 may include acrylic-epoxy material.

The common electrode 210 is disposed on the over-coating layer 205.

The liquid crystal layer 3 is disposed between the first substrate and the second substrate. The liquid crystal layer 3 includes liquid crystal molecules having optical anisotropy. The liquid crystal molecules are driven by electric fields, so that an image is displayed by selectively passing or blocking light through the liquid crystal layer 3.

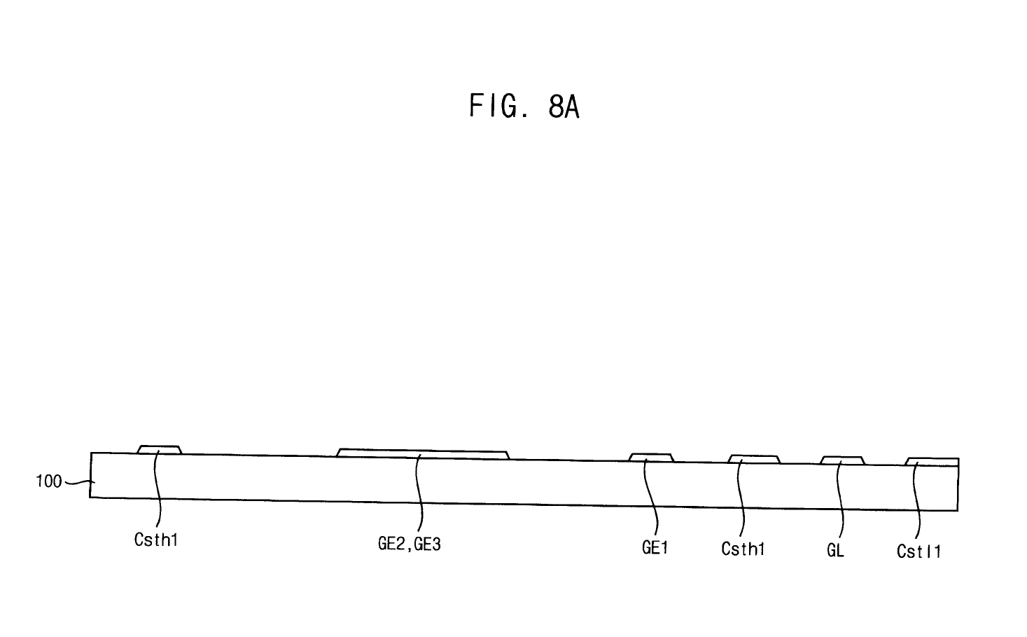

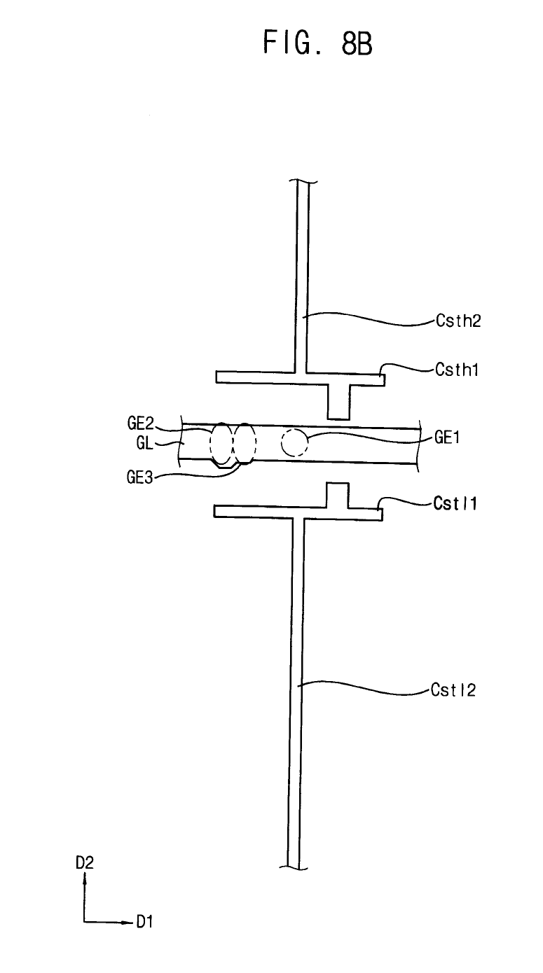

FIGS. 8A to 14 are cross-sectional views illustrating a method of manufacturing the display panel of FIG. 5.

Referring to FIGS. 8A and 8B, a metal layer is formed on a first base substrate 100, and then the metal layer may be partially etched by a photolithography process or an etching process using an additional etching mask. Hence, a gate pattern is formed. The gate pattern includes a first high storage line Csth1, a second high storage line (Csth2 of FIG. 5), a first low storage line Cstl1, a second low storage line (Cstl2 of FIG. 5), a gate line GL, a first gate electrode GE1, a second gate electrode GE2 and a third gate electrode GE3.

The gate line GL extends substantially in a first direction D1. The gate line GL is electrically connected to the first gate electrode GE1, the second gate electrode GE2 and the third gate electrode GE3.

The first high storage line Csth1 extends substantially in the first direction D1, and is disposed adjacent to the gate line GL.

The second high storage line Csth2 is disposed between the first data line DL1 and the second data line DL2, and extends substantially in the second direction D2. The second high storage line Csth2 is electrically connected to the first high storage line Csth1.

The first low storage line Cstl1 is disposed adjacent to the gate line GL, and opposite to the first high storage line Csth1 with reference to the gate line GL. The first low storage line Cstl1 extends substantially in the first direction D1.

The second low storage line Cstl2 extends substantially in the second direction D2. The second low storage line Cstl2 is electrically connected to the first low storage line Cstl1.

The second high storage line Csth2 is electrically connected to a second low storage line of an adjacent pixel in the second direction D2. In addition, the second low storage line Cstl2 is electrically connected to a second high storage line of an adjacent pixel in the second direction D2. Thus, in the whole display panel, second high storage lines and second low storage lines may be electrically connected to each other along the second direction D2.

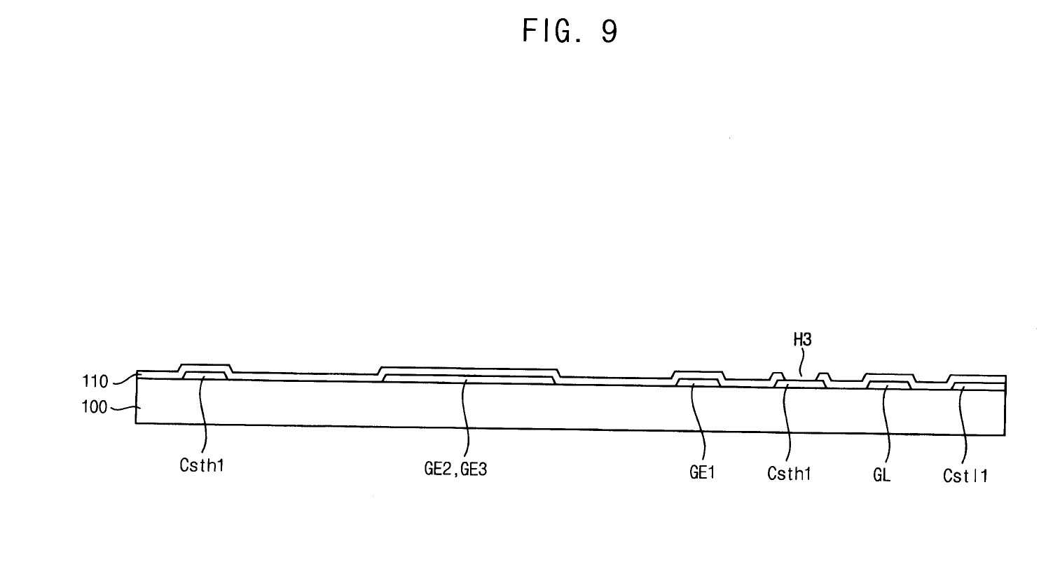

Referring to FIG. 9, a first insulation layer 110 is formed on the first base substrate 100 on which the gate pattern is formed. The first insulation layer 110 may be formed by a spin coating process, a printing process, a sputtering process, a CVD process, an ALD process, a PECVD process, an HDP-CVD process, a vacuum evaporation process, or any other suitable process, in accordance with the ingredients included in the first insulation layer 110.

A third contact hole H3 is formed through the first insulation layer 110 to expose a portion of the first high storage line Csth1.

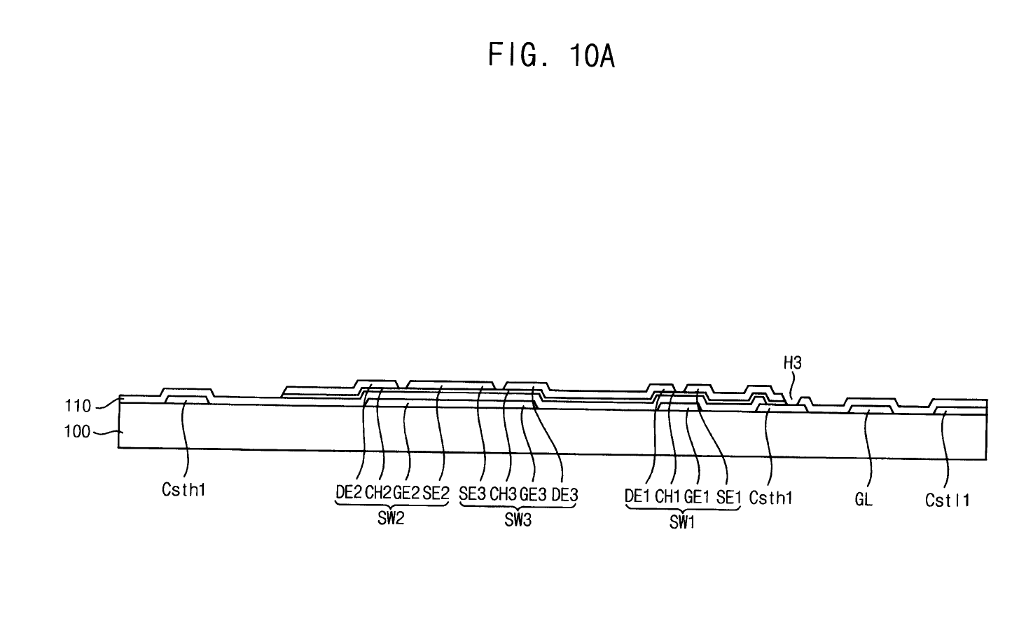

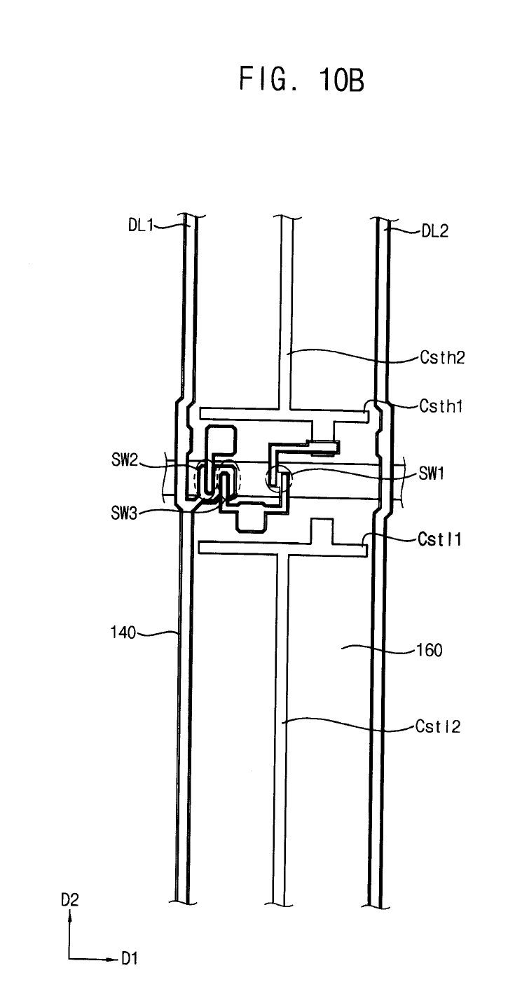

Referring to FIGS. 10A and 10B, a semiconductor layer and a metal layer are formed on the first insulation layer 110, whereupon the semiconductor layer and the metal layer may be partially etched by a photolithography process or an etching process using an additional etching mask. Hence, the channel layer having first to third channel portions CH1, CH2 and CH3, and a data pattern are formed. The semiconductor layer may include a silicon semiconductor layer including amorphous silicon (a-Si:H) and an ohmic contact layer including n+ amorphous silicon (n+ a-Si:H). In addition, the first channel portion CH1 may include an oxide semiconductor. The oxide semiconductor may include an amorphous oxide including at least one selected from the group consisting of indium (In), zinc (Zn), gallium (Ga), tin (Sn) and hafnium (Hf).

The data pattern includes a first drain electrode DE1, a first source electrode SE1, a second source electrode SE2, a second drain electrode DE2, a third source electrode SE3, a third drain electrode DE3, a first data line DL1 and a second data line DL2. For example, the semiconductor later and the metal layer are patterned at the same time, and then a portion of the patterned metal layer is removed. Hence, the first source electrode SE1 and the first drain electrode DE1 spaced apart from the first source electrode SE1 are formed. In addition, the second source electrode SE2 and the second drain electrode DE2 may be formed by removing a corresponding portion of the patterned metal layer. In addition, the third source electrode SE3 and the third drain electrode DE3 may be formed by removing a corresponding portion of the patterned metal layer.

The first drain electrode DE1, the first source electrode SE1, the first channel portion CH1 and the first gate electrode GE1 collectively form first switching element SW1.

The first source electrode SE1 may have a portion extending substantially in the second direction D2. An end portion of the first source electrode SE1 may have an edge substantially parallel to the gate line GL.

The first drain electrode DE1 is spaced apart from the first source electrode SE1. The first drain electrode DE1 may be staggered, i.e. not inline, with the first source electrode SE1. The first drain electrode DE1 may extend substantially in the second direction D2. An end portion of the first drain electrode DE1 may have an edge substantially parallel to the gate line GL.

The second drain electrode DE2, the second source electrode SE2, the second channel portion CH2 and the second gate electrode GE2 together form second switching element SW2. The second source electrode SE2 is electrically connected to the third source electrode SE3.

The third drain electrode DE3, the third source electrode SE3, third channel portion CH3 and the third gate electrode GE3 collectively form third switching element SW3. The third drain electrode DE3 is electrically connected to the first drain electrode DE1. The first source electrode SE1 at least partially fills the third contact hole H3 formed through the first insulation layer 110.

The first data line DL1 extends substantially in the second direction D2, and crosses the gate line GL. The first data line DL1 is electrically connected to second source electrode SE2 of the second switching element SW2, and to third source electrode SE3 of the third switching element SW3.

The second data line DL2 is spaced apart from the first data line DL1, extends substantially in the second direction D2, and crosses the gate line GL. The second data line DL2 is electrically connected to a second source electrode of a second switching element of an adjacent pixel, and a third source electrode of a third switching element of the adjacent pixel.

The channel layer 140 entirely or substantially entirely covers a lower surface of a data pattern. This data pattern may include the first data line DL1, the second data line DL2, a first source electrode SE1 and a first drain electrode DE1 of the first switching element SW1, a second source electrode SE2 and a second drain electrode DE2 of the second switching element SW2, and a third source electrode SE31 and a third drain electrode DE3 of the third switching element SW3. The channel layer 140 and the data pattern may therefore be formed by using the same mask. Thus, the channel layer 140 may be formed to have a shape corresponding to the data pattern. In the present exemplary embodiment, the channel layer 140 and the data pattern may be formed by using the same mask, so that the number of processes and a corresponding manufacturing cost may be decreased.

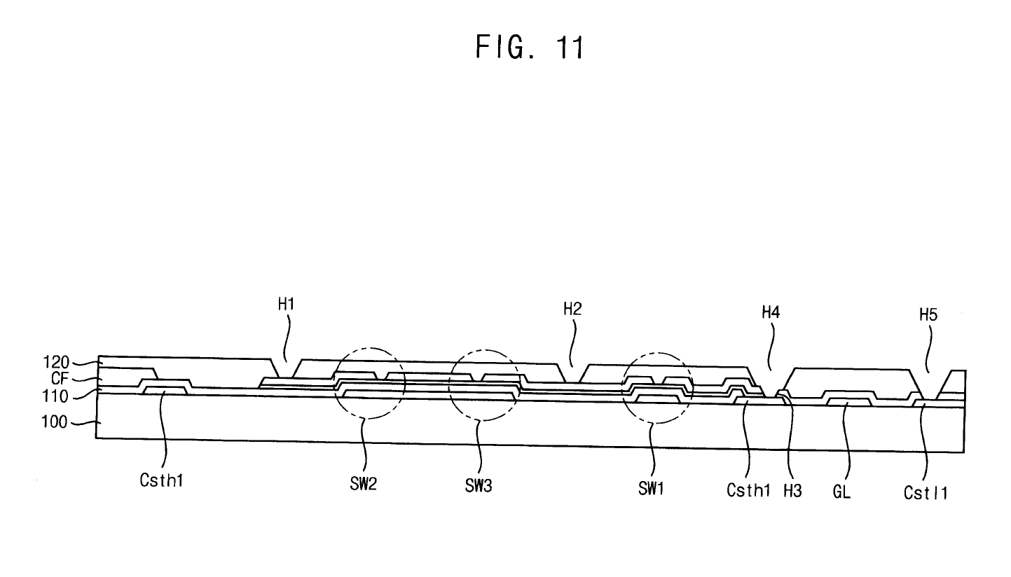

Referring to FIG. 11, a color filter CF is formed on the first insulation layer 110. A photoresist is formed on the first insulation layer 110. The photoresist is exposed using a mask, and then the photoresist is developed using a developing solution. Hence, the color filter CF may be formed.

A second insulation layer 120 is then formed on the first insulation layer 110.

A fourth contact hole H4 is formed through the second insulation layer 120 and over the third contact hole H3, so that a portion of the first high storage line Csth1 and a portion of the first source electrode SE1 are exposed.

A fifth contact hole H5 is formed through the first insulation layer 110 and the second insulation layer 120, so that a portion of the first low storage line Cstl1 is exposed.

A first contact hole H1 is formed through the second insulation layer 120, so that a portion of the second drain electrode DE2 is exposed.

A second contact hole H2 is also formed through the second insulation layer 120, so that a portion of the third drain electrode DE3 (or a portion of the first drain electrode DE1) is exposed.

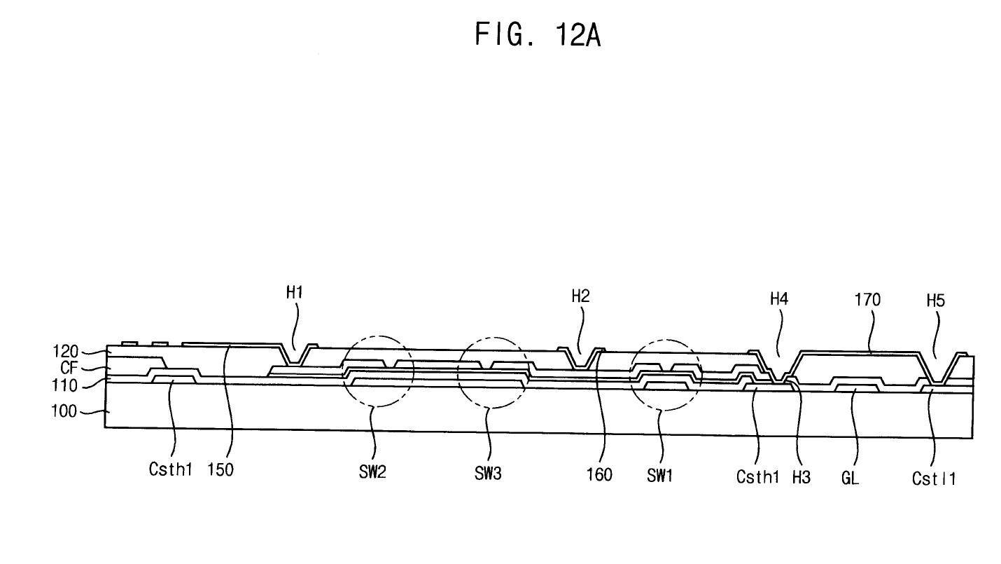

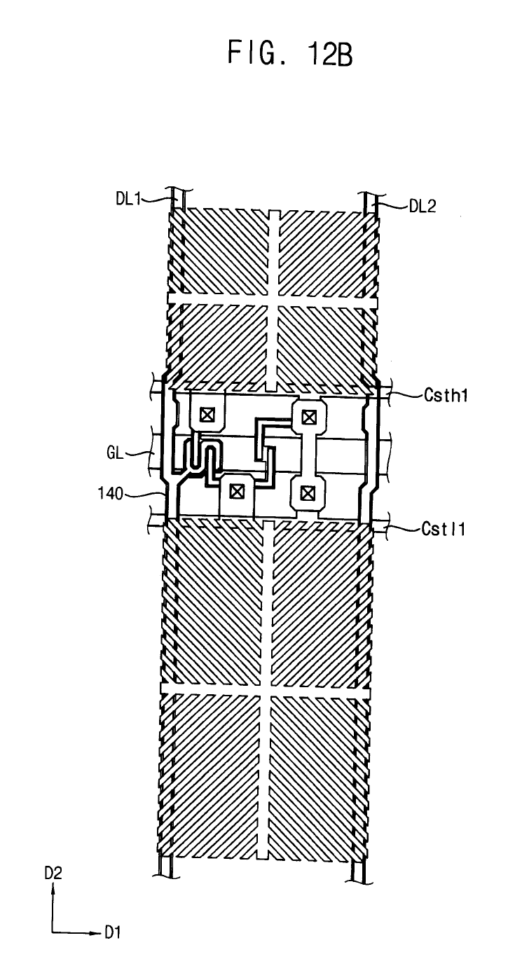

Referring to FIGS. 12A and 12B, a transparent conductive layer is formed on the second insulation layer 120, whereupon this transparent conductive layer may be partially etched by a photolithography process or an etching process using an additional etching mask. Hence, a high pixel electrode 150, a low pixel electrode 160 and a connecting electrode 170 may be formed. The transparent conductive layer may include indium tin oxide (ITO), indium zinc oxide (IZO) and the like.

The low pixel electrode 160 is disposed opposite to the high pixel electrode 150 with reference to the gate line GL, and between the first data line DL1 and the second data line DL2. The low pixel electrode 160 is electrically connected to a third drain electrode DE3 of the third switching element SW3 and a first drain electrode DE1 of the first switching element SW1 through the second contact hole H2. A boundary of the low pixel electrode 160 may overlap the first data line DL1 and the second data line DL2.

The high pixel electrode 150 is disposed adjacent to the gate line GL in the second direction D2, and between the first data line DL1 and the second data line DL2. The high pixel electrode 150 is electrically connected to a second drain electrode DE2 of the second switching element SW2 through the first contact hole H1. A boundary of the high pixel electrode 150 may overlap the first data line DL1 and the second data line DL2.

The connecting electrode 170 is electrically connected to the first source electrode SE1 of the first switching element SW1 and the first high storage line Csth1 through the third contact hole H3 and the fourth contact hole H4. In addition, the connecting electrode 170 extends generally in the second direction D2, and is electrically connected to the first low storage line Cstl1 through the fifth contact hole H5.

The high pixel electrode 150 includes a first stem 152 extending substantially in the second direction D2, and a second stem 154 extending substantially in the first direction D1 and crossing the first stem 152. The first and second stems 152 and 154 may divide the high pixel electrode 150 into four domains each of which has the same area.

The low pixel electrode 160 includes a first stem 162 extending substantially in the second direction D2, and a second stem 164 extending substantially in the first direction D1 and crossing the first stem 162. The first and second stems 162 and 164 may divide the low pixel electrode 160 into four domains each of which has the same area.

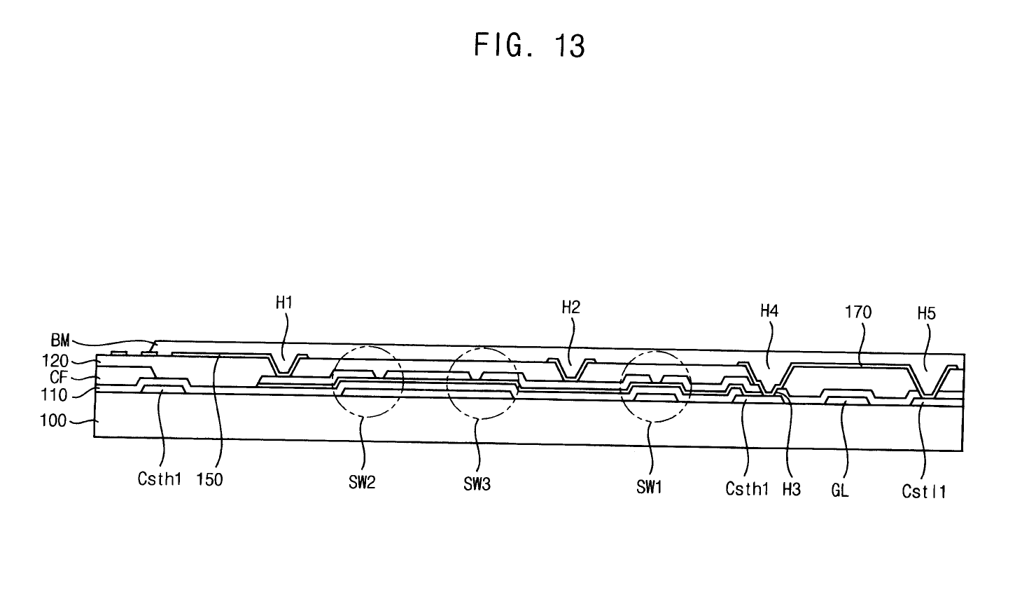

Referring to FIG. 13, a black matrix BM is formed on the second insulation layer 120. The black matrix BM overlaps or covers the first data line DL1, the second data line DL2, and the first to third switching elements SW1, SW2 and SW3. When the gate pattern includes an opaque material, the black matrix BM may overlap the first high storage line Csth1, the second high storage line Csth2, the first low storage line Cstl1 and the second low storage line Cstl2.

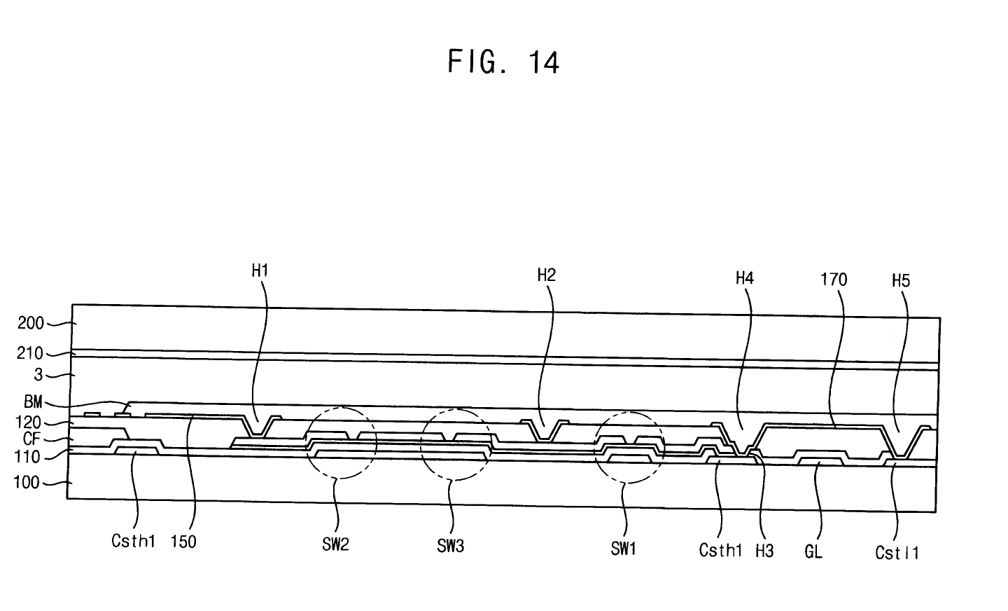

Referring to FIG. 14, a common electrode 210 is formed on a second base substrate 200. The common electrode 210 may be a transparent conductive layer. For example, the common electrode 210 may include indium tin oxide (ITO), indium zinc oxide (IZO) and the like.

The first base substrate 100, the gate pattern, the first insulation layer 110, the channel layer, the data pattern, the color filter CF, the second insulation layer 120, the high pixel electrode 150, the low pixel electrode 160, the connecting electrode 170 and the black matrix BM are included within a first substrate. The second base substrate 200 and the common electrode 210 are included within a second substrate. A liquid crystal layer 3 including liquid crystal molecules having optical anisotropy is formed between the first substrate and the second substrate.

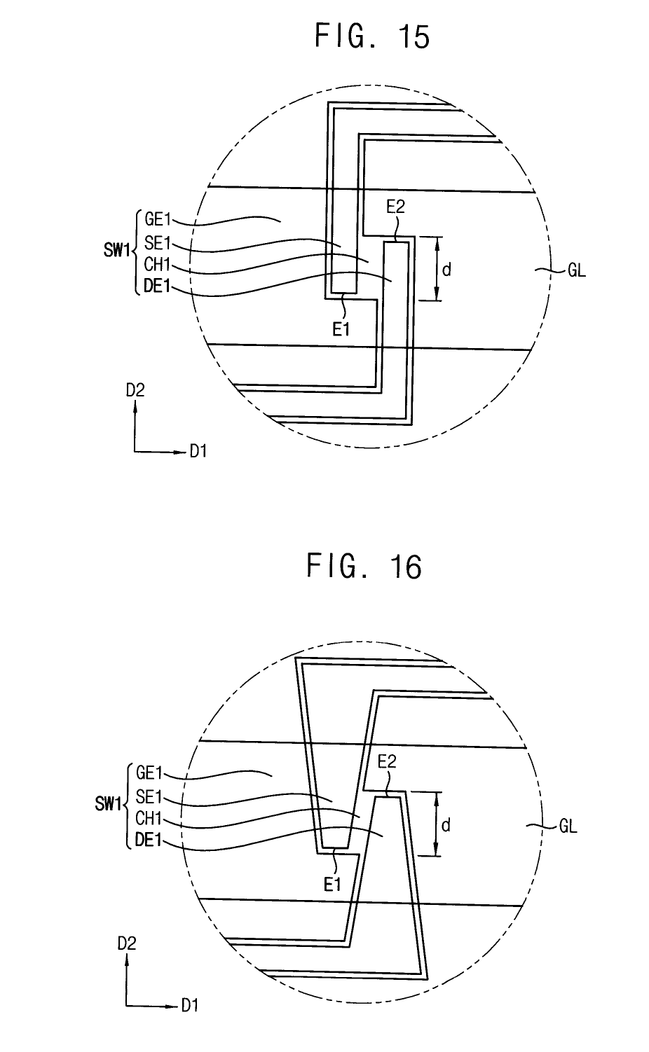

FIG. 15 is a partially enlarged view illustrating a first switching element according to an exemplary embodiment of the invention.

Referring to FIG. 15, a first switching element SW1 includes a first gate electrode GE1, a first source electrode SE1, a first drain electrode DE1 and a first channel portion CH1 connecting the first source electrode SE1 to the first drain electrode DE1. In addition, a portion of the gate line GL may form the first gate electrode GE1. The gate line GL extends substantially in a first direction D1.

The first source electrode SE1 may have a portion that extends in the second direction D2 substantially perpendicular to the first direction D1. An end portion of the first source electrode SE1 may have a first edge E1 substantially parallel to the gate line GL. For example, the first source electrode SE1 may be formed to have a rectangular shape in plan view.

The first drain electrode DE1 is spaced apart from the first source electrode SE1. The first drain electrode DE1 may be staggered with the first source electrode SE1, i.e. offset laterally so that the two electrodes DE1, SE1 are not inline with each other. The first drain electrode DE1 may extend substantially in the second direction D2. An end portion of the first drain electrode DE1 may have a second edge E2 substantially parallel to the gate line GL. For example, the first drain electrode DE1 may be formed to have a rectangular shape in plan view.

The first channel portion CH1 is formed under the first source electrode SE1 and the first drain electrode DE1. The first channel portion CH1, the first source electrode SE1 and the first drain electrode DE1 may be formed by using the same mask. Thus, both end portions of the first channel portion CH1 may be substantially parallel to the end portions of the first source electrode SE1 and the first drain electrode DE1. The end portion of the first channel portion CH1 may have straight edges and may extend from one end of one of the electrodes SE1, DE1 perpendicular to the other when viewed in plan view. Since the end portion of the first channel portion CH1 has substantially straight edges in plan view, a width d of the first channel portion CH1 may be measured accurately and precisely.

FIG. 16 is a partially enlarged view illustrating a first switching element according to another exemplary embodiment of the invention.

Referring to FIG. 16, a first switching element SW1 includes a first gate electrode GE1, a first source electrode SE1, a first drain electrode DE1 and a first channel portion CH1 connecting the first source electrode SE1 to the first drain electrode DE1. In addition, a portion of the gate line GL may form the first gate electrode GE1. The gate line GL extends substantially in a first direction D1.

The first source electrode SE1 may extend in the second direction D2 substantially perpendicular to the first direction D1. An end portion of the first source electrode SE1 may a first edge E1 substantially parallel to the gate line GL. For example, the first source electrode SE1 may be formed as a trapezoidal shape in a plan view.

The first drain electrode DE1 is spaced apart from the first source electrode SE1. The first drain electrode DE1 may be staggered, i.e. offset or not inline, with the first source electrode SE1. The first drain electrode DE1 may extend substantially in the second direction D2. An end portion of the first drain electrode DE1 may have a second edge E2 substantially parallel to the gate line GL. For example, the first drain electrode DE1 may be formed to have a substantially trapezoidal shape in a plan view.

The first channel portion CH1 is formed under the first source electrode SE1 and the first drain electrode DE1. The first channel portion CH1, the first source electrode SE1 and the first drain electrode DE1 may be formed by using the same mask. Thus, both end portions of the first channel portion CH1 may be substantially parallel to the end portions of the first source electrode SE1 and the first drain electrode DE1. The end portion of the first channel portion CH1 may have straight edges when viewed in plan view. Since the end portion of the first channel portion CH1 has straight edges in plan view, a width d of the first channel portion CH1 may be measured accurately and precisely.

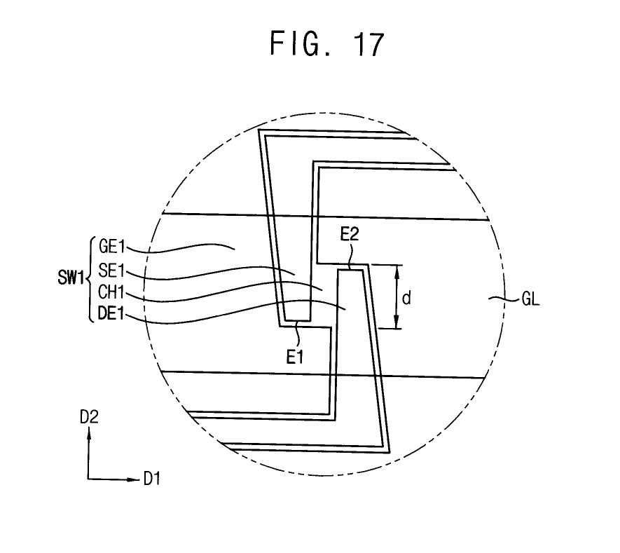

FIG. 17 is a partially enlarged view illustrating a first switching element according to still another exemplary embodiment of the invention.

Referring to FIG. 17, a first switching element SW1 includes a first gate electrode GE1, a first source electrode SE1, a first drain electrode DE1 and a first channel portion CH1 connecting the first source electrode SE1 to the first drain electrode DE1. In addition, a portion of the gate line GL may form the first gate electrode GE1. The gate line GL extends substantially in a first direction D1.

The first source electrode SE1 may extend substantially in the second direction D2 substantially perpendicular to the first direction D1. An end portion of the first source electrode SE1 may have a first edge E1 substantially parallel to the gate line GL. For example, a first side of the first source electrode SE1 is substantially perpendicular to the gate line GL and a second side of the first source electrode SE1 facing the first side is not perpendicular to the gate line GL.

The first drain electrode DE1 is spaced apart from the first source electrode SE1. The first drain electrode DE1 may be staggered, i.e. spaced apart laterally from or not inline, with the first source electrode SE1. The first drain electrode DE1 may extend substantially in the second direction D2. An end portion of the first drain electrode DE1 may have a second edge E2 substantially parallel to the gate line GL. For example, a first side of the first drain electrode DE1 is substantially perpendicular to the gate line GL and a second side of the first drain electrode DE1 opposite to the first side is not perpendicular to the gate line GL.

The first channel portion CH1 is formed under the first source electrode SE1 and the first drain electrode DE1. The first channel portion CH1, the first source electrode SE1 and the first drain electrode DE1 may be formed by using the same mask. Thus, both end portions of the first channel portion CH1 may be substantially parallel to the end portions of the first source electrode SE1 and the first drain electrode DE1. The end portion of the first channel portion CH1 may have straight edges when viewed in plan view. Since the end portion of the first channel portion CH1 has straight edges in plan view, a width d of the first channel portion CH1 may be measured accurately and precisely.

According to the present invention, a channel portion, a source electrode and a drain electrode are formed by using the same mask. Accordingly, when ends of a source electrode and a drain electrode are substantially parallel to the gate line, an end of the channel portion may be substantially parallel to the gate line.

In addition, the end of the channel portion is formed to have a straight edge in plan view, so that a width of the channel portion may be measured accurately.

In addition, since a width of the channel portion is measured accurately, a dispersion may be decreased and a display quality may be improved.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. For example, various features of the disclosed embodiments may be mixed and matched in any combination to produce further embodiments also contemplated by the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A display panel comprising:
a gate line extending substantially in a first direction;
a first data line extending in a second direction substantially perpendicular to the first direction; and
a first switching element comprising a first electrode, a second electrode and a channel layer;
wherein an end portion of the first electrode has a first edge oriented substantially perpendicular to a direction of extension of the first electrode, the second electrode extends in a direction substantially opposite to the first electrode, an end portion of the second electrode has a second edge oriented substantially perpendicular to a direction of extension of the second electrode, and the channel layer substantially entirely covers both a lower surface of the first electrode and a lower surface of the second electrode.

2. The display panel of claim 1, further comprising:
a second data line spaced apart from the first data line in the first direction, and extending substantially in the second direction;
a high pixel electrode disposed between the first data line and the second data line, and disposed adjacent to the gate line;
a low pixel electrode disposed between the first data line and the second data line, and disposed opposite to the high pixel electrode with respect to the gate line;
a high storage line extending substantially in the second direction, and overlapping the high pixel electrode; and
a low storage line extending substantially in the second direction, and overlapping the low pixel electrode.

3. The display panel of claim 2, further comprising:
a second switching element electrically connected to the gate line, the first data line and the high pixel electrode; and
a third switching element electrically connected to the gate line and the low pixel electrode,
wherein the first electrode of the first switching element is electrically connected to the high storage line, and the second electrode of the first switching element is electrically connected to the third switching element.

4. The display panel of claim 2, wherein the high storage line comprises a first high storage line extending substantially in the first direction and a second high storage line extending substantially in the second direction, and
the low storage line comprises a first low storage line extending substantially in the first direction and a second low storage line extending substantially in the second direction.

5. The display panel of claim 4, wherein the high pixel electrode comprises a first stem extending substantially in the first direction, a second stem extending substantially in the second direction, and a plurality of branches extending from the first and second stems, the high pixel electrode further having a slit structure formed by the branches,
the low pixel electrode comprises a first stem extending substantially in the first direction, a second stem extending substantially in the second direction, and a plurality of branches extending from the first and second stems, the low pixel electrode further having a slit structure formed by the branches,
the second high storage line overlaps the second stem of the high pixel electrode, and
the second low storage line overlaps the second stem of the low pixel electrode.

6. The display panel of claim 2, further comprising a connecting electrode electrically connecting the high storage line to the low storage line.

7. The display panel of claim 2, further comprising:
a common electrode facing the high pixel electrode and the low pixel electrode; and
a liquid crystal layer disposed between the high and low pixel electrodes and the common electrode.

8. The display panel of claim 2, wherein the first electrode and the second electrode have a substantially rectangular shape in plan view.

9. The display panel of claim 2, wherein the first electrode and the second electrode have a substantially trapezoidal shape in plan view.

10. The display panel of claim 2, wherein a first side of at least one of the first and second electrodes is substantially parallel to the first data line and a second side of the at least one of the first and second electrodes, which is opposite to the first side, is not parallel to the first data line.

11. The display panel of claim 2, wherein a portion of the high pixel electrode overlaps the first and second data lines, and
a portion of the low pixel electrode overlaps the first and second data lines.

12. The display panel of claim 2, wherein the high storage line, the low storage line and the gate line are formed from a same layer.

13. A method of manufacturing a display panel comprising:
forming a gate pattern on a substrate, the gate pattern comprising a gate line, a high storage line and a low storage line;
forming a first insulation layer on the substrate;
forming a first data line, a second data line, a data pattern and an active pattern, wherein the data pattern comprises a first electrode and a second electrode, and an end portion of the first electrode has a first edge substantially perpendicular to a direction of extension of the first electrode, the second electrode extends in a direction substantially opposite to the first electrode, an end portion of the second electrode has a second edge substantially perpendicular to a direction of extension of the second electrode, and the active pattern is disposed under the data pattern to substantially entirely cover a lower surface of the data pattern;
forming a second insulation layer on the first insulation layer; and
forming a high pixel electrode, a low pixel electrode and a connecting electrode connecting the high storage line and the low storage line.

14. The method of claim 13, wherein:
the gate line extends substantially in a first direction, the first data line extends in a second direction substantially perpendicular to the first direction, and the second data line is spaced apart from the first data line in the first direction, and extends substantially in the second direction,
the high pixel electrode is disposed between the first data line and the second data line and is disposed adjacent to the gate line,
the low pixel is electrode disposed between the first data line and the second data line and is disposed opposite to the high pixel electrode with respect to the gate line,
the high storage line extends substantially in the second direction, and overlaps the high pixel electrode, and
the low storage line extends substantially in the second direction, and overlaps the low pixel electrode.

15. The method of claim 14, wherein the gate line, the first data line and the high pixel electrode are electrically connected to a second switching element;
the gate line, the first data line and the low pixel electrode are electrically connected to a third switching element; and
the gate line, the third switching element and the high storage line are electrically connected to a first switching element.

16. The method of claim 15, further comprising:
forming a first contact hole through the first insulation layer to expose the high storage line before forming the data pattern,
wherein the high storage line is connected to a first electrode of the first switching element through the first contact hole.

17. The method of claim 16, further comprising:
forming a second contact hole through the second insulation layer to expose the first electrode of the first switching element, and forming a third contact hole through the second and first insulation layers to expose the low storage line before forming the connecting electrode,
wherein the connecting electrode is electrically connected to the high storage line and to a first source electrode of the first switching element through the first and second contact holes, and is electrically connected to the low storage line through the third contact hole.

18. The method of claim 13, wherein the first electrode and the second electrode have a substantially rectangular shape in plan view.

19. The method of claim 13, wherein the first electrode and the second electrode have a substantially trapezoidal shape in plan view.

20. The method of claim 13, wherein a first side of one of the first and second electrodes is substantially parallel to the first data line and a second side of the one of the first and second electrodes, which is opposite to the first side, is not parallel to the first data line.
